(19) United States
(12) Patent Application Publication
(10) Pub. No.: US 2006/0009360 A1
(43) Pub. Date: Jan. 12, 2006

(54) New adjuvant composition

(76) Inventors: Robert Pifer, Elkhorn, WI (US); Manfred Biermann, Clearwater, FL (US); Jianhua Mao, West Chester, OH (US); Frank Lachut, West Chester, OH (US); Michael P. Pompeo, Sumter, SC (US)

Correspondence Address: COGNIS CORPORATION;PATENT DEPARTMENT, 300 BROOKSIDE AVENUE, AMBLER, PA, 19002, US

(21) Appl. No.: 11/159,487

(22) Filed: Jun. 23, 2005

Related U.S. Application Data
(60) Provisional application No. 60/583,244, filed on Jun. 25, 2004.

(51) Int. Cl. A01N 57/18

(52) U.S. Cl. 504/206

(57) ABSTRACT

The present invention is directed to pesticidal formulations utilizing novel alkylpolyglycoside amines as adjuvants. The pesticidal formulation need not, but may, include an additional eye irritation-reducing complex. The adjuvant is particularly useful with glyphosate (N-(phosphonomethyl)glycine) compositions. Methods for using these pesticidal formulations are also disclosed.

### BACKGROUND OF THE INVENTION

1. Field of the Invention

An adjuvant composition for use with a pesticide includes an alkyl or alkenyl polyglycoside amine and/or its derivatives. This adjuvant composition can be used alone, or it may have added to it an additional compound or compounds which further reduce the potential for eye irritation caused by the alkyl or alkenyl polyglycoside amine or other reagents used in a pesticide formulation. The additional compound(s) may also function as chelating agents capable of enhancing the effectiveness of the pesticide component of the formulation.

2. Background of the Invention

Insecticides, insect repellents, fungicides, bactericides, bacteriostats, herbicides, and plant growth regulators are normally formulated into various products for use on crops for insect control, weed control and the like. The products are generally formulated as liquids, powders, or granules. Solvents, emulsifiers, dispersing agents and wetting agents are normally incorporated into such compositions to ensure that the pesticide composition will disperse or emulsify in a tank mixture at the point of application. They also serve to ensure optimum delivery and efficacy of the pesticide to the targeted pest or substrate. Where utilized, surfactants may affect many properties of the formulation such as solubility, volatility, specific gravity, viscosity, corrosivity, efficacy, and freezing and flash points.

Sometimes the surfactants incorporated in pesticide formulations are not sufficient to fully ensure stable tank mixes when such tank mixes contain multiple components. Thus, it may be necessary to add adjuvants to the tank mix for full stability. Adjuvants may also improve the biological activity of many pesticides and there are many adjuvant formulations that have been developed for this purpose.

Surfactants are the most important and widely used adjuvants or co-formulants utilized with pesticides, ranging from being minor components to the sole component of the adjuvant composition or formulation. It is widely known that adding surfactant-based adjuvants to a tank mixture will realize the desired stabilization of the pesticide and any additional formulation components.

One class of adjuvants that has found success in, for example, N-(phosphonomethyl)glycine (glyphosate) formulations, are polyoxyalkylene aliphatic amines. While polyoxyalkylene aliphatic amine-based adjuvants have excellent surfactant properties that often enhance the efficacy of herbicides such as glyphosate, they unfortunately are eye irritants and as such must be handled with a high degree of caution.

WO 00/41567 and U.S. Pat. No. 6,432,878, the contents of each of which are incorporated by reference herein, disclose compositions useful in reducing eye irritancy of adjuvants, particularly polyoxyalkylene aliphatic amine-based adjuvants.

Reducing or eliminating the eye irritancy of adjuvants used with pesticides, without reducing the efficacy of the pesticidal formulations containing the surfactants, is a highly desirable goal. The protection of the applicator and personnel preparing the surfactant and pesticidal formulations from eye damage is of paramount importance. Reducing the eye irritancy of the adjuvants and pesticidal formulations containing the adjuvant increases the use that can be made of such products, while lessening the possibility of injury to personnel handling and using them. Adjuvants with little or no eye irritancy are especially desirable, conferring both a safety and economic advantage.

### BRIEF SUMMARY OF THE INVENTION

The present invention is directed to an adjuvant composition for pesticides. The new adjuvant comprises a family of novel alkyl or alkenyl polyglycoside amines and/or their derivatives, with or without other conventional components, such as polyhydric alcohols and defoamers. Where polyhydric alcohols are utilized with the new adjuvant in the pesticidal formulation, the polyhydric alcohols are preferably a mixture comprising a trihydric alcohol, such as glycerol, and one or more diols, such as ethylene glycol and/or propylene glycol. The new adjuvant may be used without a separate eye irritation-reducing compound.

In other embodiments of the present invention, a separate eye irritation-reducing compound, which is preferably a carboxylic acid, may be added to the pesticidal formulation, which contains the adjuvant component, a pesticide component and optionally, additional reagents. The separate compound may also function as a chelating agent capable of enhancing the effectiveness of the pesticide component.

Where utilized in a sprayable formulation, the adjuvant composition of the present invention increases the area covered by a given volume of pesticide, and helps the active ingredient of the pesticide formulation to wet out on the surface and penetrate either the leaf barrier or the protective coating of an insect.

The adjuvant according to the invention may be particularly useful in N-(phosphonomethyl)glycine (glyphosate) herbicide formulations. The invention is also directed to a method of killing or controlling weeds or insects by contacting the weeds or insects with a biologically effective amount of the formulation according to the present invention.

### DETAILED DESCRIPTION OF THE INVENTION

The term “pesticide” or “pesticide composition” as used herein includes chemicals and microbial agents used as active ingredients of products for control of crop and lawn pests and diseases, animal ectoparasites, and other pests in public health. A pesticide is any substance, whether naturally or synthetically derived, which (a) has biological activity or is capable of releasing in a plant or animal an ion, moiety or derivative which has biological activity, and (b) is applied to a plant or animal with the intent or result that the substance or its biologically active ion, moiety or derivative enter living cells or tissues of the plant or animal and elicit a stimulatory, inhibitory, regulatory, therapeutic, toxic or lethal response in the plant itself or in a pathogen, parasite or feeding organism present in or on the plant. Examples of pesticides include, but are not limited to, chemical pesticides (such as herbicides, algicides, fungicides, bactericides, viricides, insecticides, aphicides, miticides, nematicides, molluscicides, and the like), plant growth regulators, fertilizers and nutrients, gametocides, defoliants, desiccants, pest repellants, synergists, herbicide safeners (which reduce the phytotoxicity of herbicides to crop plants), preservatives, mixtures thereof, and the like.

As used herein, a “pesticidally effective amount” is that amount of a pesticide or herbicide which, upon application, either reduces the presence of animal or plant pests or diseases, or enhances a plant's or animal's resistance to an animal or plant pest or disease.

The term “pesticide formulation” as used herein includes a pesticide, an adjuvant, and any other components or reagents added thereto including, but not limited to, polyhydric alcohols, defoamers, additional eye irritation-reducing compounds, chelating agents, solvents, water and the like.

Alkyl and alkenyl polyglycosides are known to those skilled in the art and are commercially available. The term alkyl polyglycoside is used herein refers to alkyl polyglycosides, alkenyl polyglycosides, their amounts???? and mixtures thereof. The amination of an alkyl polyglycoside to obtain an alkyl polyglycoside amine in accordance with the present invention can occur in accordance with several methods, including some known to those skilled in the art. In a preferred embodiment, the nitrogen group is introduced into the alkyl polyglycoside as follows: the alkyl polyglycoside is first reacted with acrylonitrile in the presence of an alkaline catalyst, such as potassium hydroxide or sodium methoxide. The resulting product is then subjected to hydrogenation or a chemical reduction to reduce the nitirile (—CN) group to a CH₂NH₂ group. Alkoxylation, such as by ethoxylation or propoxylation, is then carried out by typical alkoxylation methods known to those skilled in the art with an alkaline catalyst, such as potassium hydroxide or sodium methoxide. The alkyl polyglycoside amine thus obtained can be further reacted with an acid or an acid chloride.

The adjuvant composition of the present invention preferably includes alkyl polyglycoside amines and their derivatives having the following chemical structures: 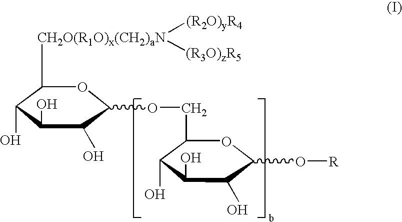
where R is an alkyl or alkenyl group having 4 to 30, preferably 6 to 22, more preferably 6 to 18, carbon atoms; (R₁O)ₓ is a random or block polyalkoxide wherein R₁ has 2 to 6 carbon atoms; (R₂O)_{y} is a random or block polyalkoxide wherein R₂ has 2 to 6 carbon atoms; (R₃O)_{z} is a random or block polyalkoxide wherein R₃ has 2 to 6 carbon atoms; x, y and z can be any number from 0 to 100; a is 1 to 12; b is 0 to 15; and R₄ and R₅ can each be H or an alkyl or alkenyl group having 1 to 24 carbon atoms; 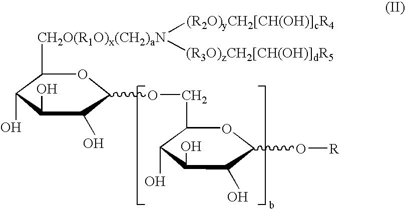
where R is an alkyl or alkenyl group having 4 to 30, preferably 6 to 22, more preferably 6 to 18, carbon atoms; (R₁O)ₓ is a random or block polyalkoxide wherein R₁ has 2 to 6 carbon atoms; (R₂O)_{y} is a random or block polyalkoxide wherein R₂ has 2 to 6 carbon atoms; (R₃O)_{z} is a random or block polyalkoxide wherein R₃ has 2 to 6 carbon atoms; x, y and z can be any number from 0 to 100; a is 1 to 12; b is 0 to 15; c is O to 6; d is O to 6; and R₄ and R₅ can each be H or an alkyl or alkenyl group having 1 to 24 carbon atoms; 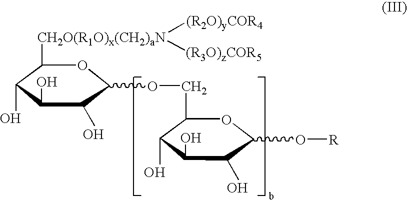
where R is an alkyl or alkenyl group having 4 to 30, preferably 6 to 22, and more preferably 8 to 18, carbon atoms; (R₁O)ₓ is a random or block polyalkoxide wherein R₁ has 2 to 6 carbon atoms; (R₂O)_{y} is a random or block polyalkoxide wherein R₂ has 2 to 6 carbon atoms; (R₃O)_{z} is a random or block polyalkoxide wherein R₃ has 2 to 6 carbon atoms; x, y and z can be any number from 0 to 100; a is 1 to 12; b is 0 to 15; and R₄ and R₅ can each be H or an alkyl or alkenyl group having 1 to 24 carbon atoms.

The alkyl polyglycoside amines are present in the adjuvant in an amount sufficient to increase the efficacy of the pesticide or plant growth regulator with which it is formulated. The adjuvants are generally mixed with the pesticide to form a concentrate which is diluted with water to provide a mixture which is applied to a substrate such as a plant, animal or locus where the pest is to be eliminated. Generally the concentrate is diluted from about 10 to about 150 times with water. The typical amount of alkyl polyglycoside amine as the adjuvant according to the present invention can range from about 5% to about 85% by weight of the pesticidal formulation with the preferred amount typically ranging from about 10% to about 30% by weight of the pesticidal formulation. Where the alkylpolyglycoside amine is used in conjunction with other materials to form an adjuvant, the total amount of adjuvant may range from about 55% to about 75% by weight of the pesticidal formulation.

The optimum amount of adjuvant to be utilized depends on variables such as the identity of the pesticide, how the pesticide formulation is to be applied, the storage and transportation of the adjuvant and pesticide composition, the conditions of use of the pesticidal formulation, etc., and is readily determinable by those skilled in the art. The adjuvant of the present invention can contain optional components to improve the water solubility of the formulation, suppress gel formation and/or reduce its low temperature viscosity. The need for such components will depend upon several factors, especially the identity of the components comprising the pesticidal formulation.

When used as an adjuvant, the adjuvant according to the invention is typically used to form a concentrate at a level of from about 50 ml to about 250 ml of adjuvant per liter of aqueous solution containing about 300 g/L or more of the pesticide. The concentrate is then diluted in a “tank mix” for applilcation to the locus of the weeds. In an alternative, the adjuvant of the invention can be added directly to the “tank mix” when used as an adjuvant for glyphosate, the adjuvant of the invention is typically used at a level of 50 ml to 150 ml of adjuvant per liter of aqueous solution containing more than about 400 grams per liter of glyphosate.

Although not required, the adjuvants of the present invention may also include an additional eye irritation reducing component, which is preferably a carboxylic acid. Such a carboxylic acid interacts with any other components added to the pesticide thereby further reducing any eye irritation of the pesticidal formulation.

Where utilized as a component of the pesticidal formulation, the carboxylic acids according to the invention also function as chelating agents capable of forming a complex with metal ions in aqueous solution thereby reducing or eliminating the inactivating effect of metal ions on the activity of the pesticide in the formulated product. It is well known that chelating agents are compounds having donor atoms that can combine by coordinate bonding with a metal ion to form a cyclic structure known as a chelating complex. The donor atoms are present in separate functional groups within the same molecule.

For example, N-(phosphonomethyl)glycine (glyphosate) is an herbicide that may be partially or completely inactivated in aqueous solution by the presence of metal ions, particularly polyvalent metal ions such as Ca⁺² and Fe⁺³. Thus, the carboxylic acids according to the invention are those having one or more carboxyl groups and one or more other functional groups capable of interacting with polyvalent metal ions in aqueous solution such that a stable metal chelate is formed. For example, hydroxycarboxylic acids chelate through the oxygen donor atoms located in the carboxyl group and the alcohol group. Other such carboxylic acids include, but are not limited to, aminocarboxylic acids such as ethylenediaminetetraacetic acid and its salts.

The preferred carboxylic acids are hydroxycarboxylic acids that contain one or more carboxyl groups and one or more hydroxyl groups. Such acids that are particularly useful in the practice of the present invention include, but are not limited to, citric acid, glycolic acid, gluconic acid, alpha-hydroxybutyric acid, malic acid, saccharic acid, mandelic acid, tartaric acid, glyceric acid. Citric acid is especially preferred because it is non-toxic and can be used at relatively low concentrations. Another advantage to the use of citric acid is its ability to increase the phytotoxicity of the herbicide glyphosate because citric acid readily complexes with metals such as calcium and iron, metals which are known to deactivate glyphosate salts. The amount of such carboxylic acids that can be present in the formulations according to the invention is an eye irritation-reducing amount which is any amount required to reduce any eye irritation of a pesticidal formulation according to the invention to an acceptable level. Such an amount will be readily determinable by those skilled in the art and will typically vary from about 0.05% to about 5% by weight of the adjuvant, more preferably from about 1% to about 3% by weight of the adjuvant. However, as noted above, the adjuvant of the present invention generally does not require an additional eye irritation-reducing amount of a carboxylic acid, so in many instances the carboxylic acid functions solely as a chelating agent to enhance the effectiveness of the pesticide component of the formulation of the present invention. Where they function solely as chelating agents, the carboxylic acids are preferably present in an amount readily determinable by those skilled in the art and will typically vary from about 0.05% to about 5% by weight of the adjuvant, more preferably from about 1% to about 3% by weight of the adjuvant.

The adjuvants according to the invention may also contain a mixture of polyhydric alcohols and/or a defoamer. A polyhydric alcohol or polyol is a compound having at least two alcohol functionalities. The mixture of polyhydric alcohols is preferably comprised of at least one trihydric alcohol, preferably glycerol, and at least one glycol, preferably ethylene glycol, propylene glycol or a combination thereof. While the mixture of polyhydric alcohols can contain any combination of polyols in any relative amount, it is preferably comprised of a combination of glycerol, ethylene glycol and/or propylene glycol present in an amount of from about 10% to about 35% by weight of the adjuvant, more preferably from about 20% to about 30% by weight of the adjuvant. The relative amounts of the various polyhydric alcohols within the mixture will vary according to the nature of the pesticide and the end use of the pesticidal formulation and will typically be ascertainable to those skilled in the art.

Suitable defoamers are known to those skilled in the art and include those products sold under the name Agnique® by Cognis Corporation (Cincinnati, Ohio). Where utilized, a defoamer may be present in an amount ranging from about 0.01% to about 10% by weight of the adjuvant.

The adjuvants according to the invention can be combined with a pesticidally effective amount of any type of pesticide to form a pesticidal formulation. The adjuvants may be utilized with any and all herbicides, insecticides, insect repellents, fungicides, plant growth regulators and other tank-mix adjuvants.

Specific examples of pesticides with which the adjuvants according to the invention can be formulated include, but are not limited to, phosphoric herbicides such as N-(phosphonomethyl)glycine; acifluorfen (5-[2-chloro-4-(trifluoromethyl)phenoxy]-2-nitrobenzoic acid); chloramben (3-amino-2,5-dichlorobenzoic acid); 2,4-D(2,4-dichlorophenoxy)acetic acid; endothal (7-oxabicydo(2.2.1)heptane-2,3-dicarboxylic acid); mecoprop (2-(2-methyl-4-chlorophenoxy)propionic acid); picloram (4-amino-3,5,6-trichloropyridine-2-carboxylic acid); 2,4,5-T(2,4,5-trichlorophenoxy)acetic acid; benzac (2,3,6-trichlorobenzoic acid); dicamba (3,6-dichlor-o-anisic acid); MCPA (4-chloro-o-tolyloxyacetic acid); dalapon (2,2-dichloropropionic acid); dichlorprop (2-(2,4-dichlorophenoxy)propionic acid); MCPB (4-(4-chloro-o-tolyloxy)butyric acid); bialaphos (L-2-amino-4-((hydroxy)(methyl)phosphinoyl)butyryl-L-alanyl-L-alanine); glufosinate ((3-amino-3-carboxypropyl)methylphosphinate); imazethapyr (2-[4,5-dihydro4-methyl-4-(1-methylethyl)-5-oxo-1-H-imidazol-2-yl]-5-ethyl-3-pyridinecarboxylic acid); imazaquin (2-[4,5-dihydro4-methyl4(1-methylethyl)-5-oxo-1H-imidazol-2-yl]-3-quinolinecarboxylic acid); mixtures thereof, and the like. Preferred results, however, are obtained with the herbicide glyphosate whose activity is derived from N-phosphonomethylglycine. Glyphosate is normally formulated from water soluble salts thereof. The use of glyphosate and its derivatives as herbicides is disclosed in U.S. Pat. No. 3,853,530, the entire contents of which are incorporated by reference herein.

Other biologically active materials which can be used to make compositions according to the invention include, but are not limited to, insecticides such as O,O-diethyl O-(2-isopropyl-4-methyl-6-pyrimidinyl)phosphorothioate; O,O-diethyl S-2-[(ethylthio)ethyl]phosphorodithioate; O,O-dimethyl O-(3-methyl-4-nitrophenyl)thiophosphate; O,O-dimethyl-(N-methylcarbamoylmethyl) phosphorodithioate; O,O-dimethyl S-(N-methyl-N-formylcarbamoylmethyl) phosphorodithioate; O,O-dimethyl S-2-[(ethylthio)ethyl]phosphorodithioate; O,O -diethyl S-2-[(ethylthio)ethyl]phosphorodithioate; O,O-dimethyl-1-hydroxy-2,2,2-trichloroethylphosphonate; O,O-diethyl-O-(5-phenyl-3-isooxazolyl)phosphorothioate; O,O-dimethyl O-(2,5-dichloro-4-bromophenyl)phosphorothioate; O,O-dimethyl-O—)₃-methyl-4-methylmercaptophenyl)thiophosphate; O-ethyl O-p-cyanophenyl-O-phenylphosphorothioate; O,O-dimethyl-S-(1,2-dicarboethoxyethyl)phosphorodithioate; 2-chloro-(2,4,5-trichlorophenyl)vinyldimethyl phosphate; 2-chloro-1-(2,4-dichlorophenyl)vinyidimethyl phosphate; O,O-dimethyl O-p-cyanophenyl phosphorothioate; 2,2-dichlorovinyl dimethyl phosphate; O,O-diethyl 0-2,4-dichlorophenyl phosphorothioate; ethyl mercaptophenylacetate O,O-dimethyl phosphorodithioate; S-[(6-chloro-2-oxo-3-benzooxazolinyl)methyl]O,O-diethyl phosphorodithioate; 2-chloro-1-(2,4-dichlorophenyl)vinyl diethylphosphate; O,O -diethyl O-(3-oxo-2-phenyl-2H-pyridazine-6-yl)phosphorothioate; O,O-dimethyl S-(1-methyl-2-ethylsulfinyl)-ethyl phosphorothiolate; O,O-dimethyl S-phthalimidomethyl phosphorodithioate; O,O-diethyl 2,2,2-trichloroethanol; 2-(p-tert-butyl-phenoxy)isopropyl-2′-chloroethylsulfite; azoxybenzene; di-(p-chlorophenyl)-cyclopropyl carbinol; di[tri(2,2-dimethyl-2-phenylethyl)tin]oxide; 1-(4-chlorophenyl)-3-(2,6-difluorobenzoyl)urea; S-tricyclohexyltin O,O-diisopropylphosphorodithioate; 2-methyl-2-(methylthio)propionaldehyde 0-(mehtylcarbamoyl)oxime; ethyl [2-(4-phenoxyphenoxy)ethyl]carbamate; butyl-2,3-dihydro-2,2-dimethylbenzofuran-7-yl N,N′-dimethyl-N,N′-thiodicarbamate; 1-naphthylmethyl carbamate; 2-(ethylthiomethyl)phenyl methylcarbamate; 5-(4phenoxybutyl)dimethylthiocarbamate; dimethyl N,N′-(thiobis(methylimino)carbonyloxy)bis(ethanimidothioate); (RS)-α-cyano-3-phenoxybenzyl-(RS)-2-(4-chlorophenyl)-3-methylbutyrate; (RS)-α-cyano-3-phenoxyphenyl-(RS)-2,2-dichloro-1-(4-ethoxyphenyl)cyclopropanecarboxylate; (RS)-α-cyano-3-phenoxybenzyl-N-(2-chloro-α,α,α-trifluoro-p-tolyl)-D-valinate; 3-phenoxybenzyl-(1RS)-cis,trans-3-(2,2-dichlorovinyl)-2,2-diemthylcyclopropanedicarboxylate.

Insect repellents which may be employed include, but are not limited to, 2-ethyl-1,3-hexanediol; N-octyl bicycloheptene dicarboximide; N,N-diethyl-M-toluamide; 2,3,4,5-Bis (2-butylene) tetrahydro-2-furaldehyde; Di-n-propyl isocinchomeronate; and 2-hydroxyethyl-n-octyl sulfide.

Fungicides which may also be employed include, but are not limited to, 3,3′-ethylenebis(tetrahydro-4,6-dimethyl-2H-1,3,5-thiadiazine-2-thione); zinc or manganese ethylenebis(dithiocarbamate); bis-(dimethyldithiocarbamoyl)disulfide; zinc propylenebis (dithiocarbamate); bis(dimethyldithiocarbamoyl) ethylenediamine; nickel dimethyldithiocarbamate; methyl-1(butylcarbamoyl)-2-benzimidazolecarbamate; 1,2-bis(3-methoxycarbonyl-2-thioureido)benzene; 1-isopropylcarbamoyl-3-(3,5-dichlorophenyl)hydantoin; potassium N-hydroxymethyl-N-methyldithiocarbamate; 5-methyl-10-butoxycarbonylamino-10,11-dehydrodibenzo (b,f)azepine; pyridine fungicides such as zinc bis(1-hydroxy-2(1H)pyridinethionate, 2-pyridinethiol-1-oxide sodium salt; O,O -diisopropyl S-benzylphosphorothioate; O-ethyl S,S-diphenyldithiophosphate; phthalimide fungicides such as N-(2,6-p-diethylphenyl)phthalimide and N-(2,6-diethylphenyl)-4-methylphthalimide; dicarboxyimide fungicides such as N-trichloromethylthio-4-cyclohexene-1,2-dicarboxyimide and N-tetrachloroethylthio-4-cyclohexene-1,2-dicarboxyimide; 5,6-dihydro-2-methyl-1,4-oxathine-3-carboxanilido-4,4-dioxide; 5,6-dihydro-2-methyl-1,4-oxathine-3-carboxanilide; naphthoquinone fungicides such as 2,3-dichloro-1,4-naphthoquinone, 2-oxy-3-chloro-1,4-naphthoquinone copper sulfate, pentachloronitrobenzene; 1,4-dichloro-2,5-dimethoxybenzene; 5-methyl-s-triazol-(3,4-b)benzothiazole; 2-(thiocyanomethylthio)benzothiazole; 3-hydroxy-5-methylisooxazole; N-2,3-dichlorophenyltetrachlorophthalamic acid; 5-ethoxy-3-(trichloromethyl)-1,2,4-thiadiazole; 2,4-dichloro-6-(O-chloroanilino)-1,3,5-triazine; 2,3-dicyano-1,4-dithioanthraquinone; copper 8-quinolinate; polyoxine; validamycin; cycloheximide; iron methanearsonate; diisopropyl 1,3-dithiolane-2-iridene malonate; 3-allyloxy-1,2-benzoisothiazol-1,1-dioxide; kasugamycin; Blasticidin S; 4,5,6,7-tetrachlorophthalide; 3-(3,5-dichlorophenyl)₅-ethenyl-5-methyloxazolidine-2,4-dione; N-(3,5-dichlorophenyl)-1,2-dimethylcyclopropane-1,2-dicarboxyimide; S-n-butyl-5′-para-t-butylbenzyl-N-3-pyridyldithiocarbonylimidate; 4-chlorophenoxy-3,3-dimethyl-1-(1H,1,3,4-triazol-1-yl)-2-butanone; methyl-D, L-N-(2,6-dimethylphenyl)-N-(2′-methoxyacetyl)alaninate; N-propyl-N-[2-(2,4,6-trichlorophenoxy)ethyl]imidazol-1-carboxamide; N-(3,5-dichlorophenyl) succinimide; tetrachloroisophthalonitrile; 2-dimethylamino-4-methyl-5-n-butyl-6-hydroxypyrimidine; 2,6-dichloro-4-nitroaniline; 3-methyl-4-chlorobenzothiazol-2-one; 1,2,5,6-tetrahydro-4H-pyrrolol-[3,2,1-i,j]quinoline-2-one; 3′-isopropoxy-2-methylbenzanilide; 1-[2-(2,4-dichlorophenyl)₄-ethyl-1,3-dioxirane-2-ylmethyl]-1H, 1,2,4-triazol; 1,2-benzisothiazoline-3-one; basic copper chloride; basic copper sulfate; N′-dichlorofluoromethylthio-N,N-dimethyl-N-phenyl sulfamide; ethyl-N-(3-dimethylaminopropyl)thiocarbamate hydrochloride; piomycin; S,S-6-methylquinoxaline-2,3-di-yldithiocarbonate; complex of zinc and manneb; di-zinc bis(dimethyldithiocarbamate) ethylenebis(dithiocarbamate).

Plant growth regulators which may also be employed include, but are not limited to, N-methoxycarbonyl-N′4-methylphenylcarbamoylethylisourea and 1-(4-chlorophenylcarbamoyl)-3-ethoxycarbonyl-2-methylisourea; sodium naphthaleneacetate; 1,2-dihydropyridazine-3,6-dione; gibberellins; triazine herbicides such as 2-methylthio-4,6-bisethylamino-1,3,5-triazine, 2-chloro-4,6-bisethylamino-1,3,5-triazine, 2-methoxy-4-ethylamino-6-isopropylamino-1,3,5-triazine, 2-chloro-4-ethylamino-6-isopropylamino-s-triazine, 2-methylthio-4,6-bis(isopropylamino)-S-triazine and 2-methylthio-4-ethylamino-6-isopropylamino-s-triazine; phenoxy herbicides such as 2,4-dichlorophenoxyacetic acid (and methyl, ethyl, and butyl esters thereof), 2-chloro-4-methylphenoxyacetic acid, 4-chloro-2-methylphenoxyacetic acid and ethyl 2-methyl-4-chlorophenoxybutylate; diphenylether herbicides such as 2,4,6-trichlorophenyl-4′-nitrophenylether, 2,4-dichlorophenyl-4′-nitrophenylether and 3,5-dimethylphenyl-4′-nitrophenylether; urea herbicides such as 3-(3,4-dichlorophenyl)-1-methoxy-1-methyl urea, 3-(3,4-dichlorophenyl)-1,1-dimethylurea and 3-(4-chlorophenyl)-1,1-dimethyl urea; carbamate herbicides such as 3-methoxycarbonylaminophenyl-N-(3-methylphenyl)carbamate, isopropyl-N-(3-chlorophenyl)carbamate and methyl-N-(3,4′-dichlorophenyl)carbamate; uracil herbicides such as 5-bromo-3-sec-butyl-6-methyluracil and 1-cyclohexyl-3,5-propyleneuracil; thiolcarbamate herbicides such as S-(4-chlorobenzyl)-N,N-diethylthiolcarbamate, S-ethyl-N-cyclohexyl-N-ethylthiolcarbamate, S-ethyl-hexahydro-1H-azepine-1-carbothioate and S-ethyl-N,N-di-n-propyl-thiocarbamate; pyridinium herbicides such as 1,1′-di-methyl-4,4′-bispyridinium dichloride; aniline herbicides such as α,α,α-trifluoro-2,6-dinitro-N,N-dipropyl-p-toluidine, 4-(methylsulfonyl)-2,6-dinitro-N,N-dipropylaniline and N[3],N[3]-diethyl-2,4-dinitro-6trifluoromethyl-1,3-phenylene diamine; acid anilide herbicides such as 2-chloro-2′,6′-diethyl-N-(butoxymethyl)acetoanilide, 2-chloro-2′,6′-diethyl-N-(methoxymethyl)acetoanilide, and 3,4-dichloropropioneanilide; pyrazole herbicides such as 1,3-dimethyl-4-(2,4-dichlorobenzoyl)-5-hydroxypyrazole and 1,3-di-methyl-4-(2,4-dichlorobenzoyl)-5-(p-toluenesulfonyloxy)pyrazole; 5-tert-butyl-3-(2,4-dichloro-5-isopropoxyphenyl)-1,3,4-oxadiazoline-2-one; 2-[N-isopropyl,N-(4-chlorophenyl)carbamoyl]4-chloro-5-methyl-4-isooxazoline-3-one; 3-isopropylbenzo-2-thia-1,3-diazinone-(4)-2,4-dioxide; and 3-(2-methylphenoxy)pyridazine.

The compositions according to the invention may also contain, for example, dyes, additional surfactants and solvents where required.

While the adjuvants of the present invention may be used with any pesticide, whether in the form of an aqueous solution, emulsifiable liquid or wettable powder, in one embodiment, the adjuvants of the present invention may be used in the preparation of pesticidal formulations designed to be delivered by spraying, particularly sprayable herbicidal formulations. When combined with such a pesticide, the adjuvants according to the invention may be made into a concentrate which can subsequently be diluted with water to form an aqueous pesticidal formulation ready for use by spraying.

Since glyphosate in acid form has limited water solubility (about 1.2%), the water soluble salts of glyphosate are normally used for most applications. Among the water soluble salts of glyphosate are the trimethylsulfonium salt, the ammonium salt, the isopropylamine salt, and the alkali metal salts, such as sodium and potassium. Due to their solubility in water, these compounds are the agriculturally acceptable glyphosate-containing compounds generally used in commerce.

The relative amounts of herbicide, water and adjuvant in the aqueous pesticidal formulations of this invention will vary depending upon many factors including, but not limited to, the identity and properties of the pesticide, e.g. herbicide, method of application, locus to which the pesticide is applied, etc. The weight ratio of glyphosate expressed as acid equivalent to adjuvant is normally in the range of 1:1 to 10:1, more preferably from 4:1 to 5:1.

Combinations of the adjuvant and pesticide may be used to treat a variety of pests found on crops including, but not limited to, insects, weeds, and the like. Formulations containing a herbicidal pesticide such as glyphosate and the formulations according to the invention may be particularly effective at killing and/or controlling weeds.

Listed below in Table 1 is an example of an adjuvant composition that can be formulated in accordance with the present invention. It should be understood that any numerical value provided is approximate and should be construed to mean approximately or about that number.

TABLE 1
ADJUVANT COMPOSITION

| COMPONENT | % |
|---|---|
| APG Amine | 70 |
| citric acid (50% aqueous solution) | 4 |
| polyhydric alcohol (glycerol) | 20 |
| propylene glycol | 5.9 |
| Defoamer* | 0.1 |

*Agnique DFM IIIS, available from Cognis Corporation (Cincinnati, OH).

It will be understood that various modifications may be made to the embodiments disclosed herein. Therefore, the above description should not be construed as limiting, but merely as exemplifications of preferred embodiments. For example, pesticides other than glyphosates can be utilized in the pesticidal formulations described herein. Those skilled in the art will envision other modifications within the scope and spirit of the claims appended hereto.

We claim:

1: A water-soluble or water-dispersible pesticidal formulation possessing reduced eye irritancy comprising an alkyl polyglycoside amine and a pesticidally effective amount of a pesticide.

2: The pesticidal formulation of claim 1 wherein the alkyl polyglycoside amine comprises the following structure: 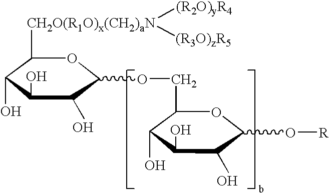
where R is an alkyl or alkenyl group having 6 to 22 carbon atoms; (R₁O)ₓ is a random or block polyalkoxide wherein R₁ has 2 to 6 carbon atoms; (R₂O)_{y} is a random or block polyalkoxide wherein R₂ has 2 to 6 carbon atoms; (R₃O)_{z} is a random or block polyalkoxide wherein R₃ has 2 to 6 carbon atoms; x, y and z can be any number from 0 to 100; a is 1 to 12; b is 0 to 15; and R₄ and R₅ can each be H or an alkyl or alkenyl group having 1 to 24 carbon atoms.

3: The pesticidal formulation of claim 1 wherein the alkyl polyglycoside amine comprises the following structure: 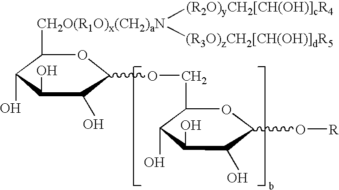
where R is an alkyl or alkenyl group having 6 to 22 carbon atoms; (R₁O)ₓ is a random or block polyalkoxide wherein R₁ has 2 to 6 carbon atoms; (R₂O)_{y} is a random or block polyalkoxide wherein R₂ has 2 to 6 carbon atoms; (R₃O)_{z} is a random or block polyalkoxide wherein R₃ has 2 to 6 carbon atoms; x, y and z can be any number from 0 to 100; a is 1 to 12; b is 0 to 15; c is O to 6; d is 0 to 6; and R₄ and R₅ can each be H or an alkyl or alkenyl group having 1 to 24 carbon atoms.

4: The pesticidal formulation of claim 1 wherein the alkyl polyglycoside amine comprises the following structure: 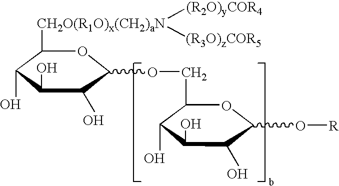
where R is an alkyl or alkenyl group having 6 to 22 carbon atoms; (R₁°)ₓ is a random or block polyalkoxide wherein R₁ has 2 to 6 carbon atoms; (R₂O)_{y} is a random or block polyalkoxide wherein R₂ has 2 to 6 carbon atoms; (R₃O)_{z} is a random or block polyalkoxide wherein R₃ has 2 to 6 carbon atoms; x, y and z can be any number from 0 to 100; a is 1 to 12; b is 0 to 15; and R₄ and R₅ can each be H or an alkyl or alkenyl group having 1 to 24 carbon atoms.

5: The pesticidal formulation of claim 1 wherein the alkylpolyglycoside amine comprises from about 5% to about 85% by weight of the pesticidal composition.

6: The pesticidal formulation of claim 1 wherein the pesticide comprises glyphosate.

7: The pesticidal formulation of claim 1 wherein the pesticidal composition further comprises an eye irritation-reducing complex.

8: The pesticidal formulation of claim 7 wherein the eye irritation-reducing complex is an effective eye irritation-reducing amount of a carboxylic acid having the ability to complex a metal ion.

9: The pesticidal formulation of claim 8 wherein the amount of carboxylic acid comprises from about 0.05% to about 5% of the adjuvant composition.

10: The pesticidal formulation of claim 8 wherein the carboxylic acid is a hydroxycarboxylic acid.

11: The pesticidal formulation of claim 10 wherein the hydroxycarboxylic acid comprises citric acid.

12: The pesticidal formulation of claim 11 further comprising a polyhydric alcohol.

13: The pesticidal formulation of claim 12 wherein the polyhydric alcohol comprises a mixture of a trihydric alcohol with one or more diols.

14: The pesticidal formulation of claim 12 further comprising a defoamer.

15: A method of killing or controlling weeds comprising contacting the weeds with a herbicidally effective amount of a solution or dispersion of the formulation of claim 1.

16: A method of killing or controlling weeds comprising contacting the weeds with a herbicidally effective amount of a solution or dispersion of the formulation of claim 2.

17: A method of killing or controlling weeds comprising contacting the weeds with a herbicidally effective amount of a solution or disperson of a solution or dispersion of the formulation of claim 3.

18: The method of killing or controlling weeds comprising contacting the weeds with a herbicidally effective amount of the formulation of claim 4.

19: The method of killing or controlling weeds comprising contacting the weeds with a herbicidally effective amount of the formulation of claim 6.

20: The method of killing or controlling weeds comprising contacting the weeds with a herbicidally effective amount of the formulation of claim 7.

21: The method of killing or controlling weeds comprising contacting the weeds with a herbicidally effective amount of the formulation of claim 8.

22. The method of killing or controlling weeds comprising contacting the weeds with a herbicidally effective amount of the formulation of claim 12.

23: The method of killing or controlling weeds comprising contacting the weeds with a herbicidally effective amount of the formulation of claim 14.

24. The method of killing or controlling weeds comprising contacting the weeds with a herbicidally effective amount of a water soluble formulation comprising an alkylpolyglycoside amine and a herbicidally effective amount of a glyphosate.

25: The method of claim 24 wherein the water soluble formulation further comprises an eye irritation-reducing complex having the ability to complex a metal ion.

26: An alkyl polyglycoside amine of the formula: 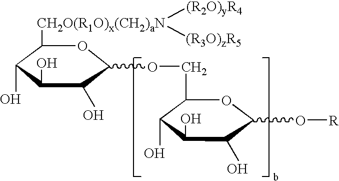
where R is an alkyl or alkenyl group having 6 to 22 carbon atoms; (R₁O)ₓ is a random or block polyalkoxide wherein R₁ has 2 to 6 carbon atoms; (R₂O)_{y} is a random or block polyalkoxide wherein R₂ has 2 to 6 carbon atoms; (R₃O)_{z} is a random or block polyalkoxide wherein R₃ has 2 to 6 carbon atoms; x, y and z can be any number from 0 to 100; a is 1 to 12; b is 0 to 15; and R₄ and R₅ can each be H or an alkyl or alkenyl group having 1 to 24 carbon atoms.

27: An alkyl polyglycoside amine of the formula: 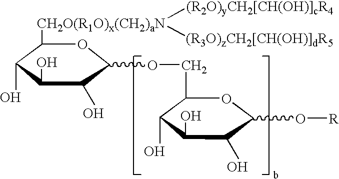
where R is an alkyl or alkenyl group having 4 to 30 carbon atoms; (R₁O)ₓ is a random or block polyalkoxide wherein R₁ has 2 to 6 carbon atoms; (R₂O)_{y} is a random or block polyalkoxide wherein R₂ has 2 to 6 carbon atoms; (R₃O)_{z} is a random or block polyalkoxide wherein R₃ has 2 to 6 carbon atoms; x, y and z can be any number from 0 to 100; a is 1 to 12; b is 0 to 15; c is 0 to 6; d is 0 to 6; and R₄ and R₅ can each be H or an alkyl or alkenyl group having 1 to 24 carbon atoms.

28: An alkyl polyglycoside amine of the formula: 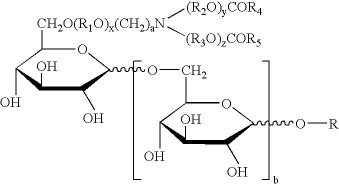
where R is H or an alkyl or alkenyl group having 4 to 30 carbon atoms; (R₁O)ₓ is a random or block polyalkoxide wherein R₁ has 2 to 6 carbon atoms; (R₂O)_{y} is a random or block polyalkoxide wherein R₂ has 2 to 6 carbon atoms; (R₃O)_{z} is a random or block polyalkoxide wherein R₃ has 2 to 6 carbon atoms; x, y and z can be any number from 0 to 100; a is 1 to 12; b is 0 to 15; and R₄ and R₅ can each be H or an alkyl or alkenyl group having 1 to 24 carbon atoms.
